(19) United States
(12) Patent Application Publication
(10) Pub. No.: US 2009/0052496 A1
(43) Pub. Date: Feb. 26, 2009

(54) Temperature testing apparatus and temperature testing method

(75) Inventors: Shunsuke Sone, Kawasaki (JP); Hirokazu Yamanishi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/153,438

(22) Filed: May 19, 2008

(30) Foreign Application Priority Data
Aug. 21, 2007 (JP) 2007-215003

(51) Int. Cl. G01K 13/00

(52) U.S. Cl. 374/141; 374/E13.001

(57) ABSTRACT

A temperature testing apparatus includes a housing, a first fan, a second fan, a heat source device, a module, and a test unit. The housing has an inlet and an outlet. The first fan is placed near the inlet and sucks air into the housing through the inlet. The second fan is placed near the outlet and exhausting the air out of the housing through the outlet. The heat source device provides hot air to the first fan. The module is installed into the housing and the module is placed at a position near the first fan. The module is placed on hot air path formed between the inlet and the outlet. And the test unit performs an evaluation test on the module.

### BACKGROUND

1. Field of the Technique

The present Technique relates to a temperature testing apparatus and a temperature testing method for electronic devices.

2. Description of the Related Art

An enterprise server for use in a large-scale system has high microprocessing power and robustness allowing operations in 24 hours and 365 days. In a case where such non-stop operations are assumed, components such as a CPU and a memory are multiplexed for supporting hot-swapping (which is replacement of a part when the device is on). For that reason, the components may be implemented in module forms like a CPU module and a memory module. The term “module” here refers to a combination of a device that is responsible for a function of a CPU or a memory, for example, and a control circuit for hot swapping, in an easily removable form. Such a module may be shipped as an accessory of a server or may be shipped alone as a maintenance part. Therefore, in the testing steps, testing the module alone is also required in addition to the testing the entire server. One of the testing steps may be a high-temperature environmental test for checking a stable operation of the module at an operating temperature.

FIG. 1 shows an explanatory diagram for a known high-temperature environmental testing method for an electronic device.

The high-temperature environmental test for a module alone is performed by implementing the module to be tested in an actual server 101 at a desired atmosphere temperature and measuring changes in temperature when a test program is operated thereon. There are roughly two kinds of method for generating and maintaining a desired atmosphere temperature.

The first method uses a large constant temperature bath 102. The server 101 is placed within the constant temperature bath 102, and a temperature control function of the constant temperature bath 102 generates an atmosphere temperature (refer to FIG. 1A). Though this method allows easy implementation of a temperature test, the size of the server 101 is limited to the size of a rack mount type, which can be placed within the constant temperature bath 102. Furthermore, a large area is required for the constant temperature bath 102 itself, which disadvantageously increases the costs and makes the purchase in large quantity difficult.

The second method uses a tent 104. This method constructs a vinyl tent 104 that can accommodate the entire server 101 with pipe frames and generates an atmosphere temperature for testing within the tent 104 with hot air 103 by a hot-air generator 105 (refer to FIG. 1B). FIG. 1B includes a temperature sensor 106 and an exhaust fan 107. Thus, a large server 101, which cannot be accommodated within the constant temperature bath 102, can be tested, and it costs less. However, the range of the atmosphere the temperature of which is to be increased is large and is not tightly closed, which disadvantageously increases the time to obtain a selected temperature. Another problem is the long waiting time for the replacement of the module to be tested. A practitioner replaces one module to be tested with the next one after the test ends. In this case however, the atmosphere temperature must be decreased to a room temperature in consideration of the safety of the practitioner. Since the temperature of the entire server 101 has been increased, it takes time to the shift to the room temperature disadvantageously.

Furthermore, the minimum number of modules must be implemented for starting the server since the temperature test is performed on the actually operating server. The implemented modules may include a module that is not to be tested. The module that is not to be tested is always exposed to a high temperature environment as testing equipment, and the life may be shortened.

In view of those problems, the temperature of a module to be tested and the vicinity can be desirably increased in a high-temperature environmental test on the module alone.

### SUMMARY

It is an object of the present technique to provide a temperature testing apparatus for increasing ambient temperature of a module to be tested implemented in an electronic device for testing.

According to an aspect of an embodiment, a temperature testing apparatus includes a housing, a first fan, a second fan, a heat source device, a module, and a test unit. The housing has an inlet and an outlet. The first fan is placed near the inlet and sucks air into the housing through the inlet. The second fan is placed near the outlet and exhausting the air out of the housing through the outlet. The heat source device provides hot air to the first fan. The module is installed into the housing and the module is placed at a position near the first fan. The module is placed on hot air path formed between the inlet and the outlet. And the test unit performs an evaluation test on the module.

### BRIEF DESCRIPTION OF THE DRAWINGS

FIGS. 1A and 1B are a known explanatory diagrams for a high-temperature environmental testing method for an electronic device;

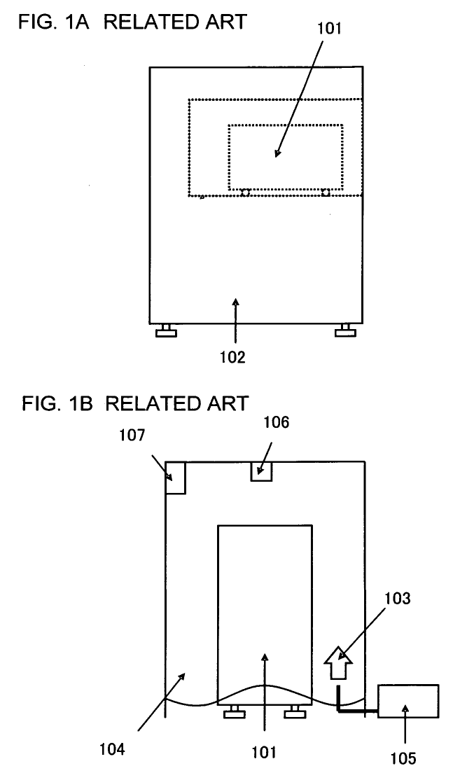

FIG. 2 is a configuration diagram of a temperature testing apparatus according to a first embodiment;

FIGS. 3A to 3C are variation examples of the embodiment of the testing apparatus;

FIG. 4 is a flowchart of processing by the temperature testing apparatus according to the first embodiment;

FIG. 5 is a configuration diagram of a temperature testing apparatus according to a second embodiment; and

FIG. 6 is a flowchart of processing by the temperature testing apparatus according to the second embodiment.

### DESCRIPTION OF THE PREFERRED EMBODIMENTS

### First Embodiment

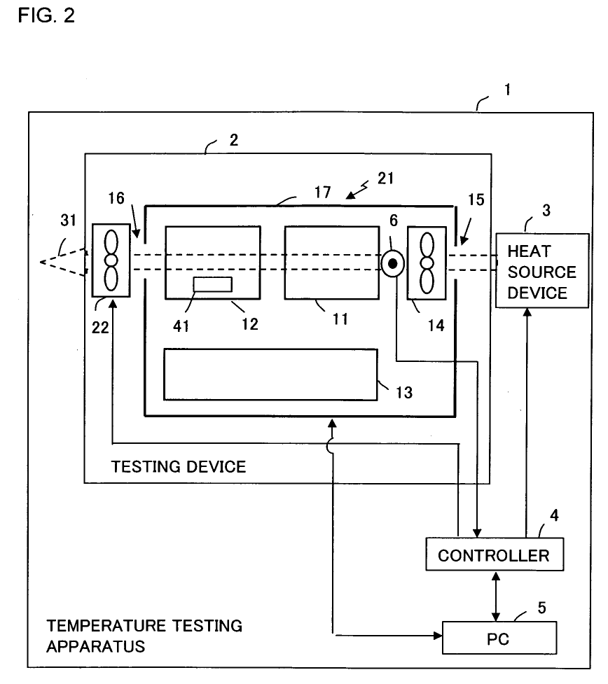

FIG. 2 shows a configuration diagram of a temperature testing apparatus according to a first embodiment.

A temperature testing apparatus 1 includes a testing device 2, a heat source device 3, a controller 4, a personal computer (which will be called PC hereinafter) 5, and a temperature sensor 6. The reference numeral 31 refers to the flow of the hot air in one direction from an inlet to an outlet (which will be called hot air path). The testing device 2 includes a combination of an electronic device 21 and a fan 22 for exhaust. The fan 22 is one example a second fan. The electronic device 21 may be a server, for example, and may have a CPU module 11, a memory module 12, a power supply unit 13 and a fan 14 for suction, which are accommodated in a housing 17. The fan 14 is one example a first fan. The term “module” refers to a combination of a device that is responsible for a function of a CPU or a memory, for example, and a control circuit for hot swapping in an easily removable form.

Since a general server adopts a Stored Program method, the server further includes a memory module 12 that stores an instruction in order to operate, in addition to the CPU module 11 that performs operations. The CPU module 11 is assumed as a module subject to a temperature test.

The memory module 12 stores an operational program by receiving it through an external port such as RS232C or by reading it out from an auxiliary storage device such as an HDD. The memory module 12 further includes a testing program 41 for performing an evaluation test on the subject CPU module 11. Therefore one example of a test unit includes the memory module 12 including the testing program 41 and the CPU module 11 for performing the testing program 41.

The power supply unit 13 supplies power to members implemented in the server, including the CPU module 11, the memory module 12 and the fan 14 for suction.

The fan 14 for suction sucks the hot air from the outside of the housing 17 through the inlet and blows it along the hot air path 31 within the housing 17. Since the fan 14 for suction can cause strong air flow in the downstream part, the CPU module 11 to be tested may be placed immediately under the downstream part of the fan 14 for suction. Thus, the temperature of the CPU module 11 can be intensively increased.

The housing 17 has an inlet 15 and an outlet 16.

The housing 17 may internally accommodate an electronic member. In a case where a duct or a rectifier, for example, is provided within the housing 17, the flow in one direction from suction to exhaust can be formed efficiently.

The fan 22 for exhaust exhausts the hot air blown along the hot air path 31 to the outside of the housing 17.

The heat source device 3 is a device that blows hot air to the inlet 15 of the electronic device 21, such as a sheathed heater, and may be a hot air generator in a case where an area is not available for the device. The heat source device 3 may be only required to place in the upstream part of the hot air path 31, and the heat source device 3 placed near the inlet 15 can conduct hot air into the housing 17 efficiently, which allows a local temperature test. The amount of heat is adjustable according to an instruction by the controller 4.

The controller 4 determines the amount of heat by the heat source device 3 according to a predetermined temperature, which is selected by the PC 5. In this case, the amount of heat is controlled with reference to the value of the temperature sensor 6. The controller 4 further notifies the PC 5 of the fact that the temperature by the temperature sensor 6 reaches the predetermined temperature. The controller 4 further starts a temperature test according to a test starting instruction from the PC 5. The controller 4 further supplies power to the fan 22 for exhaust and controls the number of rotations.

The PC 5 connects to the controller 4 and the electronic device 21. A unit including the PC 5 and the controller 4 is one example of a control section. The PC 5 instructs the controller 4 a predetermined temperature and to start testing. In response to the receipt of the notification of the fact that the predetermined temperature has been obtained from the controller 4, the PC 5 instructs the electronic device 21 to start an evaluation test on the subject CPU module 11. In response to the receipt of a test end notification from the electronic device 21, the PC 5 ends the temperature test.

The temperature sensor 6 measures an ambient temperature of the CPU module 11 to be measured. The temperature sensor 6 connects to the controller 4. Having shown in FIG. 2 that the controller 4 and the PC 5 are configured separately, the controller 4 and the PC 5 may be integrated.

As shown in FIG. 2, the hot air generated by using the heat source device 3 is sucked by the fan 14 for suction into the housing 17 through the inlet 15, and a flow of hot air is generated. The flow of hot air passes through the subject CPU module 11 along the hot air path 31 formed by the fan 14 for suction and the fan 22 for exhaust, then passes through the memory module 12 and is exhausted. Then, the passage of hot air can increase the temperature of the subject CPU module 11.

In this case, the fan 14 for suction supplies an air flow at a necessary and sufficient wind velocity and volume of air to the subject CPU module 11. The fan 22 for exhaust is responsible for establishing the air flow of hot air and exhausting the hot air to the outside of the housing 17 securely.

Here, the straight alignment of the heat source device 3 and the CPU module 11 and memory module 12 on the hot air path 31 allows a more efficient local temperature test.

The test temperature is defined by the fan 14 for suction and the heat source device 3. In order to generate the air flow and maintain the volume of air, the fan 14 for suction rotates at a constant speed at all times during the test. Since the difference between the atmosphere temperature and the temperature of a heat generating device within the CPU module 11 depend on the number of rotations, the number of rotations is desirably equal to that of the case where the subject CPU module 11 is cooled during a normal operation. The controller 4 maintains the defined temperature by using the value of the temperature sensor 6 placed immediately before the subject CPU module 11 as feedback information. Thus, the temperature near the subject CPU module 11 can be used as the test temperature.

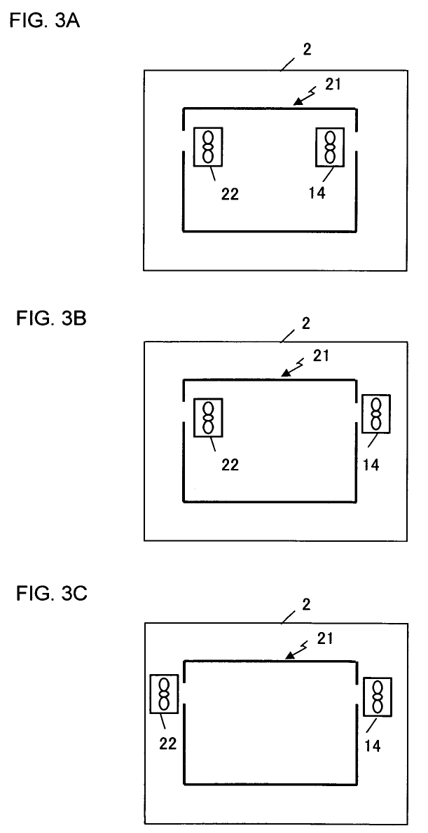

FIGS. 3A to 3C are variation examples of the embodiment of the testing apparatus.

FIGS. 3A to 3C are explanatory diagrams showing the layouts of the fan 14 for suction and the fan 22 for exhaust in the testing device 2. The testing device 2 is configured differently depending on whether the electronic device 21 has the fan 14 for suction and the fan 22 for exhaust or not.

The configuration of the testing device 2 is changed according to the configuration of the existing electronic device 21. As a result, the test environment using the existing electronic device 21 can be easily established.

FIG. 3A shows a case where the fan 14 for suction and the fan 22 for exhaust are placed within the housing 17 of the electronic device 21. Thus, the testing device 2 only includes the electronic device 21.

FIG. 3B shows a case where the fan 14 for suction is placed outside of the electronic device 21 and the fan 22 for exhaust is placed within the housing 17 of the electronic device 21. Thus, the testing device 2 includes the electronic device 21 and the fan 14 for suction.

FIG. 3C shows a case where the fan 14 for suction and the fan 22 for exhaust are placed outside of the electronic device 21. Thus, the testing device 2 includes the electronic device 21, the fan 14 for suction and the fan 22 for exhaust.

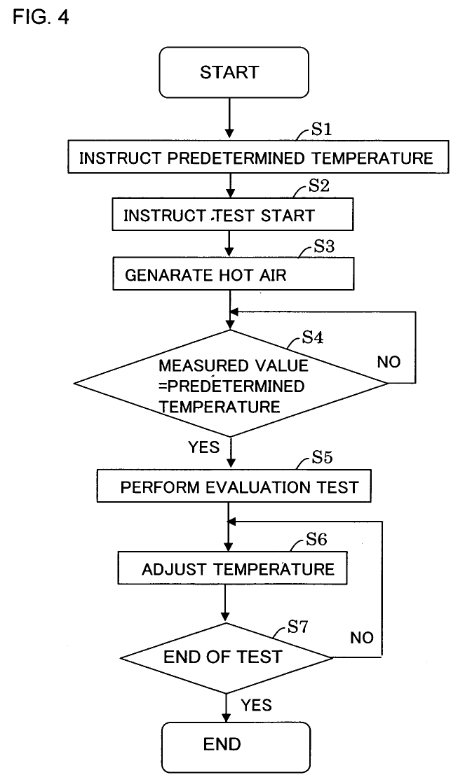

FIG. 4 shows a flowchart of processing by the temperature testing apparatus according to the first embodiment.

First of all, a practitioner sets the subject CPU module 11 to the electronic device 21. Next, the practitioner defines a predetermined temperature for testing the subject CPU module 11 to the PC 5 (step S1). For example, 40 degrees centigrade is defined. The controller 4 in response to the receipt of the instruction of the predetermined temperature from the PC 5 stores the value. Next, the practitioner inputs a test starting instruction to the PC 5 (step S2). The controller 4 receives the test starting instruction from the PC 5 and drives the heat source device 3 at the stored predetermined temperature.

The heat source device 3 generates hot air at the predetermined temperature (step S3). The hot air is sucked by the electronic device 21 and increases the ambient temperature of the CPU module 11. A duct may be provided between the heat source device 3 and the inlet 15.

Next, the controller 4 measures the temperature by using the temperature sensor 6. Then, the controller 4 checks whether the measured value is equal to the predetermined temperature or not (step S4).

If the temperature reaches the predetermined temperature, the controller 4 notifies the PC 5 of the fact that the predetermined temperature has been obtained.

The PC 5 in response to the receipt of the notification instructs the electronic device 21 to start an evaluation test on the subject CPU module 11. The electronic device 21 performs the evaluation test on the CPU module 11 (step S5).

During the evaluation test, the controller 4 adjusts the temperature such that the ambient temperature of the CPU module 11 can be kept at 40 degrees centigrade (step S6). The temperature adjustment is performed by the controller 4 by controlling the amount of heat by the heat source device 3 by measuring the temperature with the temperature sensor 6.

The PC 5 checks whether the test is to be ended or not (step S7). If the evaluation test ends, the PC 5 turns off the heat source device 3 to stop the hot air.

Since the fan 14 for suction and the fan 22 for exhaust keep operating, the inside of the electronic device 21 can have a room temperature in several minutes. As a result, a practitioner can replace with the next subject CPU module 11, and the waiting time, which has conventionally required several tens minutes, can be therefore reduced. Furthermore, no large constant baths, for example, are required to accommodate the entire housing 17, which allows the implementation in low costs.

### Second Embodiment

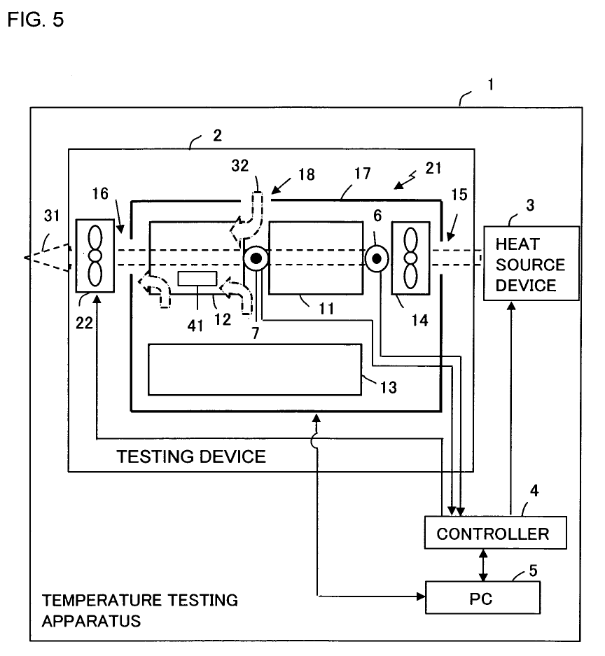

FIG. 5 shows a configuration diagram of a temperature testing apparatus according to a second embodiment.

FIG. 5 is different from FIG. 2 in that the housing 11 has a vent 18 connecting to the outside of the housing 17 at a position between the subject CPU module 11 and the memory module 12 and that a temperature sensor 7 is further provided.

The temperatures are measured at two points before and after the subject CPU module 11. The testing is performed by controlling desired temperatures at the two points.

On the hot air path 31, the air heating the CPU module 11 directly passes through the memory module 12. Therefore, the temperature of the memory module 12 is simultaneously increased.

In a case where that is a problem, the problem is addressed by the vent 18 at a position on the housing 17 between the subject CPU module 11 and the next memory module 12 for connecting the air flow and the outside of the housing 17.

The vent 18 in a case where the air flow passes through the memory module 12, which is not the subject, causes a negative pressure due to the ejector effect and allows the suction of the outside air into between the subject CPU module 11 and the memory module 12 and suppression of the increase in temperature of the non-subject memory module 12. The reference numeral 32 refers to the air flow due to the negative pressure. In this case, the fan 22 for exhaust is used for both of the exhaust of the air flow to the outside of the housing 17 and the cooling of the non-subject memory module 12. Since the negative pressure in this case depends on the number of rotations of the fan 22 for exhaust, the control over this can decrease the temperature of the air flow passing through the non-subject memory module 22. The number of rotations of the fan 22 for exhaust is controlled with voltage by the controller 4 by using the value of the temperature sensor 7 between the subject CPU module 11 and the memory module 12 as feedback information.

The variation example of the embodiment of the testing device 2 in FIG. 3 according to the first embodiment is also applied in the second embodiment except that the housing 17 of the electronic device 21 must have the vent 18.

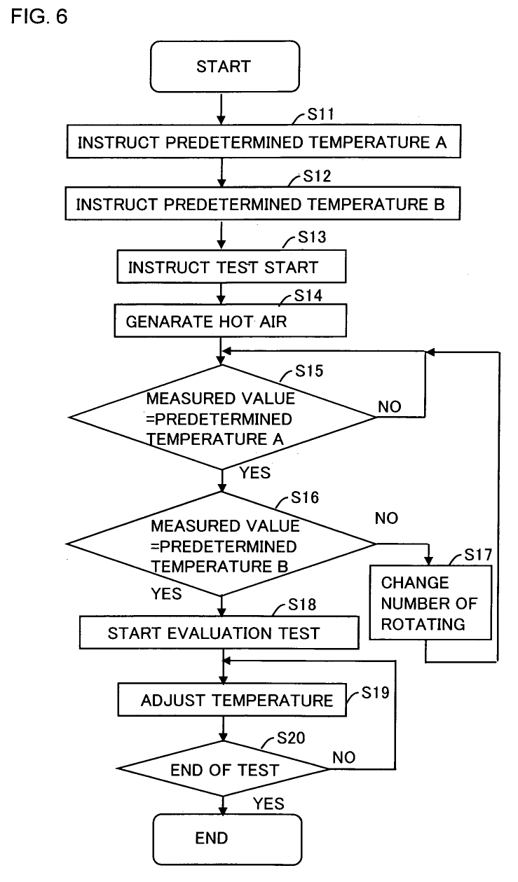

FIG. 6 shows a flowchart of the processing by the temperature testing apparatus according to the second embodiment.

First of all, a practitioner defines the subject CPU module 11 to the electronic device 21.

Next, the practitioner inputs a predetermined temperature A for testing the subject CPU module 11 to the PC 5 (step S11). For example, 40 degrees centigrade is defined. The controller 4 in response to the receipt of the instruction of the predetermined temperature A from the PC 5 stores the value.

Next, the practitioner inputs a predetermined temperature B for the non-subject memory module 12 to the PC 5 (step S12). For example, 25 degrees centigrade is defined. The controller 4 in response to the receipt of the instruction of the predetermined temperature B from the PC 5 stores the value.

Next, the practitioner inputs a test starting instruction to the PC 5 (step S13). The controller 4 receives the test starting instruction from the PC 5 and drives the heat source device 3 at the stored predetermined temperature A. The controller 4 controls the rotation of the fan 22 for exhaust based on the predetermined temperature B.

The heat source device 3 generates hot air at the predetermined temperature (step S14). The hot air is sucked by the electronic device 21 and increases the ambient temperature of the CPU module 11. A duct may be provided between the heat source device 3 and the inlet 15.

Next, the controller 4 measures the temperature. Then, the controller 4 checks whether the measured value is equal to the predetermined temperature A or not (step S15).

If the temperature reaches the predetermined temperature A, the controller 4 checks whether the measured value is equal to the predetermined temperature B or not (step S16).

If the measured value is not the predetermined temperature B, the controller 4 changes the number of rotations of the fan 22 for exhaust with the voltage (step S17). Then, the processing returns to step S15.

If the temperature reaches the predetermined temperature B, the controller 4 notifies the PC 5 of the fact that the predetermined temperature has been obtained.

The PC 5 in response to the receipt of the notification instructs the electronic device 21 to start an evaluation test on the subject CPU module 11. The electronic device 21 starts the evaluation test on the CPU module 11 (step S18).

During the evaluation test, the controller 4 adjusts the temperature such that the ambient temperature of the CPU module 11 can be kept at 40 degrees centigrade. The temperature adjustment is performed by the controller 4 by controlling the amount of heat by the heat source device 3 by measuring the temperature with the temperature sensor 6. The temperature adjustment is also performed by the controller 4 by controlling the rotations of the fan 22 for exhaust by measuring the temperature with the temperature sensor 7 (step S19).

The PC 5 checks whether the test is to be ended or not (step S20). If the evaluation test ends, the PC 5 turns off the heat source device 3 to stop the hot air.

Since the fan 14 for suction and the fan 22 for exhaust keep operating, the inside of the electronic device 21 can have a room temperature in several minutes. As a result, a practitioner can replace with the next subject CPU module 11, and the waiting time, which has conventionally required several tens minutes, can be therefore reduced. Furthermore, no large constant baths, for example, are required to accommodate the entire housing 17, which allows the implementation in low costs.

By creating a high-temperature atmosphere near the subject CPU module 11 in the temperature testing device 2 of the electronic device 21, the time for waiting the cooling for the replacement of the CPU module 11 can be reduced, and the heat damage on the non-subject memory module 12 can be minimized. Furthermore, no large constant baths are required for accommodating the entire housing 17, which allows the implementation in low costs.

Having described high-temperature tests on the CPU module 11, the same configuration is applicable to low-temperature tests. In this case, a low-temperature generator may be used instead of the heat source device.

What is claimed is:

1. A temperature testing apparatus comprising:
a housing having an inlet and an outlet;
a first fan placed near the inlet and sucking air into the housing through the inlet;
a second fan placed near the outlet and exhausting the air out of the housing through the outlet;
a heat source device providing hot air to the first fan;
a module installed in the housing, placed at a position near the first fan, and placed on hot air path formed between the inlet and the outlet by the first fan and the second fan; and
a test unit for performing an evaluation test on the module.

2. The temperature testing apparatus according to claim 1, wherein the housing installs a non-subject module excluding the module of subject to be tested, the non-subject module is placed on the hot air path, the housing has a vent near the non-subject module, and the vent connects outside air of the housing and the hot air path.

3. The temperature testing apparatus according to claim 2, further comprising:
a first measuring unit that measures ambient temperature of the subject module; and
a control section that controls temperature of the heat source device based on the measurement result by the first measuring unit and instructs the test unit to start testing upon detecting a predetermined temperature.

4. The temperature testing apparatus according to claim 3, further comprising a second measuring unit that measures ambient temperature of the non-subject module on the hot air path, wherein the control section controls the number of rotations of the second fan based on the measurement result by the second measuring unit such that the ambient temperature is a predetermined temperature.

5. A method for performing a temperature testing of a subject module installed into a housing of a temperature testing apparatus, the housing having an inlet and an outlet, the method comprising the step of:
providing a heat source device, a first fan placed near the inlet and the subject module, and a second fan placed near the outlet;
providing hot air to the first fan by the heat source device;
sucking the provided hot air into the housing through the inlet by the first fan;
exhausting the sucked hot air out of the housing through the outlet by the second fan;
forming hot air path between the inlet and the outlet by the first fan and the second fan;
detecting whether ambient temperature of the subject module is a predetermined temperature or not, the subject module being placed on the hot air path;
testing the subject module upon detecting the predetermined temperature.

6. The method according to claim 5, further comprising:
measuring ambient temperature of the subject module; and
controlling temperature of the heat source device based on the measurement result.

7. The method according to claim 6, further comprising:
providing the housing installing a non-subject module excluding the subject module to be tested, the non-subject module being placed on the hot air path, and the housing having a vent near the non-subject module for connecting outside air of the housing and the hot air path;
measuring the ambient temperature of the non-subject module excluding the subject module on the hot air path; and
controlling the number of rotations of the second fan for exhaust based on the measurement result by such that the ambient temperature is a predetermined temperature.
